(19) United States
(12) Patent Application Publication
(10) Pub. No.: US 2022/0203615 A1
(43) Pub. Date: Jun. 30, 2022

(54) 3D PRINTING DEVICE

(71) Applicant: Yang Cheng Medical Co., Ltd., Taichung (TW)

(72) Inventors: CIN-HE CHANG, Taichung City (TW); YUNG-TAI LIN, Taichung City (TW)

(21) Appl. No.: 17/234,222

(22) Filed: Apr. 19, 2021

(30) Foreign Application Priority Data
Dec. 28, 2020 (TW) 109146397

(51) Int. Cl. B29C 64/236; B29C 64/209; B29C 64/245; B29C 64/118; B29C 64/241; B29C 64/321; B29C 64/393

(52) U.S. Cl. CPC B29C 64/236; B29C 64/209; B29C 64/245; B33Y 30/00; B29C 64/241; B29C 64/321; B29C 64/393; B29C 64/118

(57) ABSTRACT

A 3D printing device includes a platform, an active rotating base, a passive rotating base, and a printing head. The platform includes a first and a second moving mechanism, and the second moving mechanism further includes a bracket. The second moving mechanism is moved on the first moving mechanism, and the bracket is moved on the second mechanism. A vessel-supporting rod sleeved with a vessel is disposed between an active rotating base and a passive rotating base, the vessel-supporting rod is rotated by a motor through the active rotating base, and the printing head connected to a third moving mechanism is disposed upon the vessel-supporting rod. The bracket is moved by the first moving mechanism and the second moving mechanism to keep a pitch remain fixed between the bracket and the printing head when the printing head is moved by the third moving mechanism to execute a printing step.

### CROSS-REFERENCE TO RELATED APPLICATION

This application claims the priority benefit of Taiwan application serial no. 109146397, filed on Dec. 28, 2020. The entirety of the above-mentioned patent application is hereby incorporated by reference herein and made a part of this specification.

### FIELD OF THE INVENTION

The invention relates to a 3D printing device, and more particularly to a 3D printing device which can produce spiral shape patterns on a surface of a vessel by printing wires.

### BACKGROUND OF THE INVENTION

3D printing, also known as additive manufacturing, is a process of material continuously depositing, and it is also known as one of fast forming technologies. The merits of 3D printing method compared to the traditional industrial manufacturing is that the manufacturing cost and difficulty will not be raised even if the complexity of the final product is increased. The printing method or theory of the conventional 3D printing devices are different with each other according to types of the raw material. For example, the thermoplastic polymers is suitable for fused deposition modeling (FDM) method to produce final products. The linear raw material is melted and injected by the printing head in FDM method, and the product can be formed after cooling. The precision of the final product is high enough and the final product can also be customized. Currently, FDM method is the most popular 3D printing technology.

When the applicable technical fields of the 3D printing devices are increased, the 3D printing device can also print biocompatible vessel structures, such as artificial blood vessels device according to the kinds of the raw material, design patterns or printing paths. However, manufacturing of the workpiece or the stereo structure by 3D printing devices of FDM method is usually performed on a platform or a plane of another workpiece. Currently, it is lack for a printing device to directly perform 3D printing on vessel shape surfaces or cylindrical shape surfaces. Therefore, it is still necessary to provide a 3D printing device performing 3D printing on non-planar workpieces such as vessel shape or cylindrical shape.

The information disclosed in this BACKGROUND OF THE INVENTION is only for enhancement of understanding of the BACKGROUND OF THE INVENTION of the described technology and therefore it may contain information that does not form the prior art that is already known to a person of ordinary skill in the art. Further, the information disclosed in the BACKGROUND OF THE INVENTION does not mean that one or more problems to be resolved by one or more embodiments of the disclosure were acknowledged by a person of ordinary skill in the art.

### SUMMARY OF THE INVENTION

According to above drawbacks, an object of the invention is to provide a 3D printing device to be capable of printing on a surface of a vessel.

It is another object of the invention is to provide a 3D printing device to form wire on the surface of a vessel, and the stress of the vessel can be increased to prevent from bending or deforming of the vessel.

In order to achieve above objects, the invention provides a 3D printing device which is used to print on a vessel, the 3D printing device comprises a platform, an active rotating base, a passive rotating base and a printing head. The platform includes a first moving mechanism and a second moving mechanism, in which the second moving mechanism is perpendicular to the first moving mechanism along a direction parallel to the platform and movably disposed on the first moving mechanism. The first moving mechanism further includes a first driving device to drive the second moving mechanism moving on the first moving mechanism back and forth from the left and right sides. The second moving mechanism further includes a bracket and a second driving device, the bracket is connected to the second driving device, and the bracket is driven by the second driving device to move on the second moving mechanism back and forth from the front and back sides. The active rotating base disposed on the platform and located at one side of the first moving mechanism, in which one end of the active rotating base is pivoted to a motor. The passive rotating base opposite to the active rotating base is movably disposed on the first moving mechanism, in which a vessel-supporting rod sleeved with the vessel is disposed between the active rotating base and the passive rotating base, one end of the vessel-supporting rod is clamped by the other end of the active rotating base opposite to the motor, the other end of the vessel-supporting rod is clamped by the passive rotating base, so the vessel-supporting rod sleeved with the vessel is located upon the first moving mechanism and the second moving mechanism. The printing head is connected to a third moving mechanism and disposed upon the vessel-supporting rod sleeved with the vessel, in which the printing head is moved by the third moving mechanism along a direction parallel to the platform, and the printing head is provided to receiving a raw material wire to print the raw material wire, whereby the printing head performs a printing step to print the raw material wire on a surface of the vessel. The vessel-supporting rod sleeved with the vessel is rotated upon the first moving mechanism by the motor, the vessel-supporting rod sleeved with the vessel is also supported by the bracket disposed on the second moving mechanism, and the printing head prints the heated raw material wire on the surface of the rotating vessel. When the printing head is moved parallel to the platform through the third moving mechanism, the bracket is moved by the first moving mechanism and the second moving mechanism to make the pitch between the print head and the bracket is to be fixed.

In a preferred embodiment, the 3D printing device further comprises a raw material feeder to provide the raw material wire.

In a preferred embodiment, the 3D printing device further comprises a wire detector, and the raw material wire is pulled from the raw material feeder to the printing head through the wire detector.

In a preferred embodiment, the 3D printing device further comprises a control unit, in which the control unit is electrically connected to the first driving device, the second driving device, the motor, the third moving mechanism and the printing head, and the control unit is used to respectively control the movement of the bracket which is driven by the first driving device and the second driving device, controls the motor to drive the rotation of the vessel-supporting rod sleeved with the vessel, controls the third moving mechanism to drive the movement of the printing head, and controls the printing head to heat the raw material wire.

In a preferred embodiment, in which the bracket further comprises a set of supporting wheels, and the bracket is used to support the vessel-supporting rod sleeved with the vessel through the set of supporting wheels.

In a preferred embodiment, in which the first moving mechanism is a sliding rail, the passive rotating base further comprises an engagement member, the length of the vessel-supporting rod is matched with that of the passive rotating base to move back and forth on the sliding rail to clamp another end of the vessel-supporting rod, and the passive rotating base is located by the engagement member.

In a preferred embodiment, in which the material of the vessel is polyurethane, polylactic acid or polycaprolactone.

In a preferred embodiment, in which the material of the raw material wire is polybutylene terephthalate, polyethylene terephthalate or thermoplastic polyurethane.

In a preferred embodiment, in which heating temperature is between 180 to 400° C.

According to the above descriptions, in the embodiments of the invention, the vessel-supporting rod sleeved with the vessel are clamped by the active rotating base and the passive rotating base, and the rotation of the vessel-supporting rod sleeved with the vessel is driven by the motor for the 3D printing device. The movement of the bracket is parallel to the platform through the first moving mechanism and the second moving mechanism, and the bracket is used to support the vessel-supporting rod. The pitch between the printing head and the bracket is fixed when the 3D printing device is executed a printing step. Thus, the 3D printing device of the invention can increase the stress of the vessel after the wire is printed on the surface of the vessel, and the bending or deformation of the vessel can be avoided to increase the printing quality of the 3D printing device.

### BRIEF DESCRIPTION OF THE DRAWINGS

FIG. 1 is a schematic view of the 3D printing device in accordance with one embodiment of the invention;

FIG. 2 is a front view of relative positions of the bracket, the vessel-supporting rod and the printing head in FIG. 1 in accordance with one embodiment of the invention;

FIG. 3 is a side view of relative positions of the bracket, the vessel, the vessel-supporting rod and the printing head in FIG. 1 in accordance with one embodiment of the invention; and

FIG. 4 is a system schematic view of electrical connections between each elements of the 3D printing device in FIG. 1 in accordance with one embodiment of the invention.

### DETAILED DESCRIPTION OF THE PREFERRED EMBODIMENT

The advantages and characteristics of the invention and the way to achieve the purpose of the invention will be easily understood by referring to the exemplary embodiments and the drawings. However, the invention can be embodied by different forms and should not be understood that the embodiments herein are limited to the invention. On the contrary, for persons ordinarily skilled in the art, the provided embodiments will express the scope of the present invention more thoroughly, more wholly and more completely.

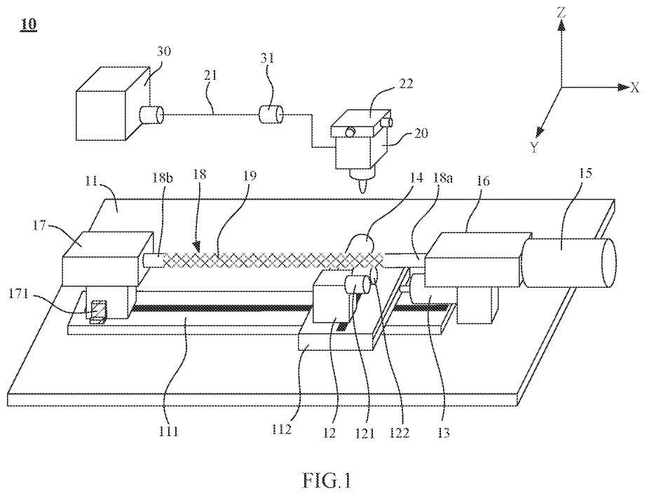

FIG. 1 is a schematic view of the 3D printing device in accordance with one embodiment of the invention. The XYZ coordinates of FIG. 1 are only use for describing the embodiment, which are not used to limit the scope of the invention. Please refer to FIG. 1, 3D printing device 10 is used to print on vessel 19, where a length of the vessel 19 is larger than an inner diameter of the vessel 19. The 3D printing device 10 includes a platform 11, an active rotating base 16, a passive rotating base 17, and a printing head 20. The platform 11 includes a first moving mechanism 111 and second moving mechanism 112, in which the second moving mechanism 112 is perpendicular and moveably disposed on the first moving mechanism 111. In the embodiment, the first moving mechanism 111 is a sliding rail and is fixed on the platform 11, the second moving mechanism 112 is another sliding rail and is disposed on the first moving mechanism 111, and the second moving mechanism 112 is moved back and forth along the X direction on the first moving mechanism 111.

Please refer to FIG. 1. The first moving mechanism 111 is provided with a first driving device 13, the second moving mechanism 112 includes a bracket 12 thereon. The bracket 12 is pivoted to a second driving device 14. In the embodiment of the invention, the second moving mechanism 112 is driven back and forth from left and right side (that is to say, the second moving mechanism is moved along the X direction) on the first moving mechanism 111 by the first driving device 13. The bracket 12 is movably disposed on the second moving mechanism 112, and is driven back and forth from front and rear side on the second moving mechanism by the second driving device 14 (that is to say the bracket 12 is moved along the Y direction). Specifically, the first driving device 13 and the second driving device can precisely control the location for the movement of the second moving mechanism 112 and the bracket 12. The first driving device 13 and the second driving device 14 can be servo motor, pneumatic cylinder or other suitable electromechanical devices.

Please refer to FIG. 1, an active rotating base 16 is disposed on the platform 11 and located at one side of the first moving mechanism 111, and a passive rotating base 17 is movably disposed on the first moving mechanism 111. A vessel-supporting rod 18 is clamped between the active rotating base 16 and the passive rotating base 17, and the vessel 19 which is to be printed is sleeved on the vessel-supporting rod 18, so two ends 18a, 18b of the vessel-supporting rod 18 are respectively clamped by the active rotating base 16 and the passive rotating base 17, and the position of the vessel-supporting rod 18 sleeved with the vessel 19 is located above the first moving mechanism 111 and the second moving mechanism 112. In the embodiment, material of the vessel 19 can be polyurethane (PU), polylactic acid (PLA), polycaprolactone (PCL), or other suitable polymers. However, due to the vessel 19 made of above materials is flexible, the vessel-supporting rod 18 is required to support the vessel 19 so the subsequent printing step with wires can be performed.

In another embodiment of the invention, the passive rotating base 17 further includes an engagement member 171 to fix the position of the passive rotating base 17 on the first moving mechanism 111. It is to be explained that the first moving mechanism 111 is a sliding rail, so the passive rotating base 17 can slide back and forth on the first moving mechanism 111 through the sliding rail. The position of the passive rotating base 17 on the first moving mechanism 111 can be adjusted to cooperate with the length of the vessel-supporting rod 18, and the passive rotating base 17 whose the position of the passive rotating base 17 on the first moving mechanism 111 is adjusted is fixed on the first moving mechanism by the engagement member 171. Therefore, the position of the passive rotating base 17 can cooperate with the various length of the vessel-supported rod 18, so the multiusability of the 3D printing device 10 can be increased.

Please refer to FIG. 1. The printing head 20 is disposed above the vessel-supporting rod 18 sleeved with the vessel 19. The printing head 20 is used to receive a raw material wire 21 from a raw material feeder 30, and the raw material wire 21 is heated by the printing head 20 to perform a printing step to print the raw material wire 21 on a surface of the vessel 19. The printing head 20 is connected to a third moving mechanism 22, and the third moving mechanism 22 is disposed above and parallel to the platform 11 to drive the movement of the printing head 20, that is, the printing head 20 is moved along X-Y plane. Specifically, the printing head 20 is provided with a heater (not shown in FIG. 1) therein, the raw material wire 21 is heated by a heater of the printing head 20, to melt the raw material wire 21 with liquid state, so as to the printing head 20 is moved above the surface of the vessel 19, and is printed with the melted raw material wire 21 on the surface of the vessel 19. In addition, due to the stretching of the raw material wire in the raw material feeder 30, the raw material feeder 30 can continuously provide the raw material wire with solid state for continuous printing by the printing head 20, until the printing step with the raw material wire on the surface of the vessel 19 is completed. In the embodiment, material of the raw material wire can be linear solid-state polymers, such as polybutylene terephthalate (PBT), polyethylene terephthalate (PET), thermoplastic polyurethane (TPU) or other suitable polymers. Besides, heating temperature of the printing head to melt the raw wire material 21 is preferably between 180 to 400° C.

Please refer to FIG. 1, a motor 15 is pivoted to one end of the active rotating base 16. When the vessel-supporting rod 18 sleeved with the vessel 19 is clamped between the active rotating base 16 and the passive rotating base 17, the motor 15 can drive the rotating of the active rotating base 16, so as to simultaneously drive the rotation of the vessel-supporting rod 18 sleeved with the vessel 19, and the passive rotating base 17 can also be rotated simultaneously with the vessel-supporting rod 18. The bracket 12 disposed on the second moving mechanism 11 supports the vessel-supporting rod 18 sleeved with the vessel 19, so as to sustain the downward pressure when the printing head 20 is printing the heated and molten raw material wire 21 on the surface of the vessel 19.

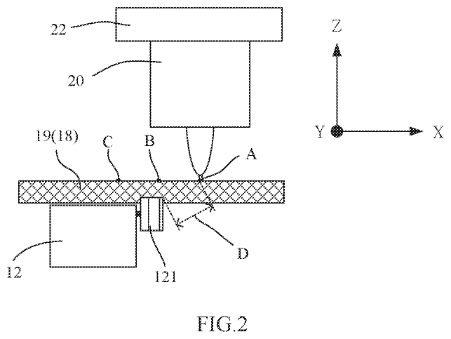

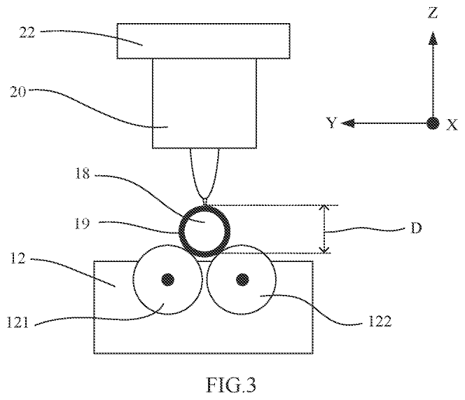

Please refer to FIGS. 1-3. FIG. 2 is a front view of relative positions of the bracket, the vessel-supporting rod and the printing head in FIG. 1 in accordance with one embodiment of the invention, and FIG. 3 is a side view of relative positions of the bracket, the vessel, the vessel-supporting rod and the printing head in FIG. 1 in accordance with one embodiment of the invention, where the XYZ coordinates shown in FIGS. 2-3 are only use for describing the embodiment, which are not used to limit the scope of the invention. When the printing head 20 is moved parallel to the platform 11 through the third moving mechanism 22, the bracket 12 is also moved by the first moving mechanism 111 and the second moving mechanism 112 to make the pitch between the printing head 20 and the bracket 12 fixed. For instance, when the printing head 20 performs the printing step to the vessel 19, the printing head 20 will change the different positions through the third moving mechanism 22 to move above printing points A, B, or C of the vessel 19 which is to be printed. The vessel 19 must be also rotated with the vessel-supporting rod 18 when the printing head 20 is executed a printing step of printing a spiral pattern passed through the points A, B and C on the vessel 19. That is to say, when the vessel-supporting rod 18 sleeved with the vessel 19 is rotated, the third moving mechanism 22 drives the movement of the printing head 20 simultaneously, and the heater of the printing head 20 will heat and melt the raw material wire 21 to print the raw material wire 21 on the surface of the vessel 19.

Please refer to FIGS. 1-3. During the printing processes, the vessel-supporting rod 18 sleeved with the vessel 19 is continuously rotated and the printing head 20 is also continuously moved by the third moving mechanism 22, so the bracket 12 must continue to move with the printing head 20 to instantly support the vessel-supporting rod 18 and the vessel 19. In addition, the bracket 12 further includes a set of supporting wheels 121 and 122, in which the supporting wheels 121 and 122 are pivoted to the bracket 12 with pivot axes (not shown) relatively to cooperate with the rotation of the vessel 19 and the vessel-supporting rod 18, thus, the vessel 19 will not be directly damaged by the friction of the bracket 12. The positions of the supporting wheels 121, 122 in Z-axis direction can be adjusted so that the outer surface of the supporting wheels 121, 122 just contact the vessel 19. In this manner, the vessel 19 and the vessel-supporting rod 18 will not be subjected to excessive upward pressure to be bend. Furthermore, in order to coordinate with various printing paths, the printing head 20 in the embodiment is moved above and parallel to the platform 11 through the third moving mechanism 22 (which is parallel to the XY plane), but the printing head 20 may not move along the direction of the length of the vessel 19 and the vessel-supporting rod 18 (which is parallel to X-axis direction). At this time, the bracket 12 can be moved along a direction parallel to the platform 11 by the first moving mechanism 111 and the second moving mechanism 112, so the pitch between the bracket 12 and the printing head 20 can be maintained. In the embodiment, the pitch is a distance D between a nozzle (not shown) of the printing head 20 and one of the supporting wheels 121 or 122. That is, the bracket 12 will not be located directly below the printing head 20, and the bending or deformation of the vessel 19 can be avoided due to the weights of the vessel 19 and the vessel-supporting rod 18 themselves.

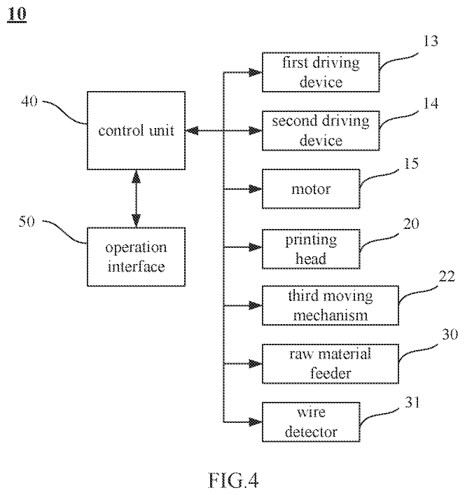

FIG. 4 is a system schematic view of electrical connections between each elements of the 3D printing device in FIG. 1 in accordance with one embodiment of the invention. Please refer to FIGS. 1 and 4. The 3D printing device 10 further includes a control unit 40 and an operation interface 50. The operation interface 50 is electrically connected to the control unit 40. Control signals sent from the control unit 40 can be received by other elements of the 3D printing device 10, and feedback signals sent from these elements of the 3D printing device 10 can also be received by the control unit 40. The control unit 40 can send the controls signals to other elements (for example, the elements shown in FIG. 4) of the 3D printing device 10, and receive the feedback signals from these elements according to the requirement of the user. The operation interface 50 is provided for inputting various print controlling parameters by user or inputting the various printing paths which is planned by the computer aided design software. In addition, the operation interface 50 can display the instant information such as printing states for user. Specifically, the control unit 40 can be programmable logic controllers (PLC), central processing units (CPU) or other electrical elements or devices suitable for number crunching. The operation interface 50 can be touch panels, personal computers or the like. In the embodiment, the control unit 40 is electrically connected to the first driving device 13, the second driving device 14, the motor 15, the printing head 20 and the third moving mechanism 22 to respectively control the first driving device 13 and the second driving device 14 to move the bracket 12, control the motor 15 to rotate the vessel-supporting rod 18 sleeved with the vessel 19, control the third moving mechanism 22 to move the printing head 20 and control the heater (not shown) of the printing head 20 to heat and melt the raw material wire 21. In addition, the control unit 40 is also electrically connected to the raw material feeder 30 to control feeding rates of the raw material wire 21.

Please refer to FIGS. 1 and 4. In another embodiment, the 3D printing device 10 further includes a wire detector 31 which is electrically connected to the control unit 40. When the raw material wire 21 is pulled from the raw material feeder 30 to the printing head 20 through the wire detector 31, the wire detector 31 is used to detect the tension of the raw material wire 21. When the tension of the raw material wire 21 is larger or smaller than a preset safety tension range, the wire detector 31 can send detecting signals with excessive or insufficient tension to the control unit 40, and control unit 40 can send control signals to the raw material feeder 30 according to these detecting signals to control the feeding rate of the raw material wire 21 to prevent crack or jam of the raw material wire 21.

In summary of the above, in the 3D printing device disclosed by the invention, the vessel-supporting rod sleeved with the vessel are clamped by the active rotating base and the passive rotating base, and the rotation of the vessel-supporting rod sleeved with the vessel is driven by the motor for the 3D printing device. The movement of the bracket is parallel to the platform through the first moving mechanism and the second moving mechanism, and the bracket is used to support the vessel-supporting rod. The pitch between the printing head and the bracket is fixed when the 3D printing device is executed a printing step. Thus, the 3D printing device of the invention can increase the stress of the vessel after the wire is printed on the surface of the vessel, and the bending or deformation of the vessel can be avoided to increase the printing quality of the 3D printing device.

The above is only the preferred embodiment of the invention, and the scope of the invention is not limited thereto, that is, the simple equivalent changes and modifications made by the scope of the invention and the description of the invention are all remain within the scope of the invention. Furthermore, terms, such as “first,” “second,” etc., mentioned in the specification or claims are simply for naming the elements or distinguishing different embodiments or scopes, and thus should not be construed as the upper or lower limit of the number of any element.

What is claimed is:

1. A 3D printing device which is used to print on a vessel, comprising:
a platform including a first moving mechanism and a second moving mechanism, wherein the second moving mechanism being perpendicular to the first moving mechanism along a direction parallel to the platform and movably disposed on the first moving mechanism, the first moving mechanism further includes a first driving device to drive the second moving mechanism moving back and forth from left and right sides on the first moving mechanism, the second moving mechanism further includes a bracket and a second driving device, the bracket is connected to the second driving device, and the bracket is driven by the second driving device to move back and forth from the front and rear sides on the second moving mechanism;
an active rotating base disposed on the platform and located at one side of the first moving mechanism, wherein one end of the active rotating base is pivoted to a motor;
a passive rotating base opposite to the active rotating base movably disposed on the first moving mechanism, wherein a vessel-supporting rod sleeved with the vessel is disposed between the active rotating base and the passive rotating base, one end of the vessel-supporting rod is clamped by the other end of the active rotating base opposite to the motor, the other end of the vessel-supporting rod is clamped by the passive rotating base, so the vessel-supporting rod sleeved with the vessel is located upon the first moving mechanism and the second moving mechanism; and
a printing head connected to a third moving mechanism and disposed upon the vessel-supporting rod sleeved with the vessel, wherein the printing head is moved by the third moving mechanism along a direction parallel to the platform, and the printing head is provided for receiving a raw material wire to heat the raw material wire, whereby the printing head performs with a printing step to print the raw material wire on a surface of the vessel;
wherein the vessel-supporting rod sleeved with the vessel is rotated upon the first moving mechanism by the motor, the vessel-supporting rod sleeved with the vessel is also supported by the bracket disposed on the second moving mechanism, and the printing head print the heated raw material wire on the surface of the rotating vessel;
wherein when the printing head is moved parallel to the platform through the third moving mechanism, the bracket is moved by the first moving mechanism and the second moving mechanism to make the pitch between the print head and the bracket is to be fixed.

2. The 3D printing device of claim 1, further comprising a raw material feeder to provide the raw material wire.

3. The 3D printing device of claim 2, further comprising a wire detector, and the raw material wire is pulled from the raw material feeder to the printing head through the wire detector.

4. The 3D printing device of claim 1, further comprising a control unit, wherein the control unit is electrically connected to the first driving device, the second driving device, the motor, the third moving mechanism and the printing head, and the control unit is used to respectively control the movement of the bracket which is driven by the first driving device and the second driving device, control the motor to drive the rotation of the vessel-supporting rod sleeved with the vessel, control the third moving mechanism to drive the movement of the printing head, and control the printing head to heat the raw material wire.

5. The 3D printing device of claim 1, wherein the bracket further comprises a set of supporting wheels, and the bracket is used to support the vessel-supporting rod sleeved with the vessel through the set of supporting wheels.

6. The 3D printing device of claim 1, wherein the first moving mechanism is a sliding rail, the passive rotating base further comprises an engagement member, the length of the vessel-supporting rod is matched with that of the passive rotating base to move back and forth on the sliding rail to clamp another end of the vessel-supporting rod, and the passive rotating base is located by the engagement member.

7. The 3D printing device of claim 1, wherein the material of the vessel is polyurethane, polylactic acid or polycaprolactone.

8. The 3D printing device of claim 1, wherein the material of the raw material wire is polybutylene terephthalate, polyethylene terephthalate or thermoplastic polyurethane.

9. The 3D printing device of claim 1, wherein heating temperature of the printing head is between 180 to 400° C.
